(19) United States
(12) Patent Application Publication
(10) Pub. No.: US 2018/0146821 A1
(43) Pub. Date: May 31, 2018

(54) COOKWARE

(71) Applicant: Good Food Machine Co., Ltd., Taichung (TW)

(72) Inventor: CHEN-YUAN LU, Taichung (TW)

(21) Appl. No.: 15/361,388

(22) Filed: Nov. 26, 2016

(51) Int. Cl. A47J 36/38; A47J 36/06; B65D 25/28; A47J 45/06

(52) U.S. Cl. CPC A47J 36/38; A47J 36/06; B65D 2525/283; A47J 45/063; B65D 25/2802

(57) ABSTRACT

A cookware includes a body having a space defined therein and the space communicates with an opening in the top of the body. Two lugs extend from outside of the body and are located close to the top of the body. A cover is removably mounted to the body and seals the opening. The cover has a handle extending centrally from the top thereof. A first hole is defined centrally through the handle. Steam can escape from the first hole during cooking. The lugs provide proper friction for grip when the user moves the cookware.

### BACKGROUND OF THE INVENTION

### 1. Fields of the Invention

The present invention relates to a cookware, and more particularly, to a cookware having a body and a cover.

### 2. Descriptions of Related Art

The conventional cookware generally comprises a bowl-shaped body and two lugs extend radially from outside of the body so that the users hold the lugs to move the cookware. A cover is mounted to the body and seals the inner space of the body. Food is put in the space of the body and the cover is mounted to the body. The body with the cover are put on fire or heat to cook the food. It is noted that the cover does not have any hole for steam to release therefrom, so that the steam escapes from gap between the cover and the body and spreads on the stove to make the kitchen messy. The steam contains very high temperature which may also hurt the users.

Besides, the lugs usually are made as a flat plate which provide less friction, the users may slip the cookware when moving the cookware. The food in the cookware drops on the floor or table, or even on the user's hand or body, this is dangerous.

The present invention intends to provide a cookware that is easily held and the steam can be escaped from holes through the cover so that the shortcomings mentioned above are eliminated.

### SUMMARY OF THE INVENTION

The present invention relates to a cookware and comprises a body having an opening defined in the top thereof. A space is defined in the body and communicates with the opening. Two lugs extend from outside of the body and are located close to the top of the body. A cover has a handle extending centrally from the top thereof. A first hole is defined centrally through the handle. The cover is removably mounted to the body and seals the opening.

Preferably, the body has a stepped portion defined in the inner periphery thereof. The stepped portion is located close to the opening. The cover is rested on the stepped portion. Preferably, the cover includes at least one second hole defined therethrough.

Preferably, each of the lugs has a groove defined in the underside thereof.

Preferably, each of the body and the cover is a circular part.

Preferably, each of the body and the cover is a rectangular part.

The primary object of the present invention is to provide a cookware that allows steam to be escaped from the first hole defined through the cover. The pressure in the cookware can be properly managed.

Another object of the present invention is to provide a cookware wherein the lugs each have a groove defined in the underside thereof so that the users can easily hold the lugs to remove the cookware.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the cookware of the present invention;

FIG. 2 is a perspective view to show the cookware of the present invention;

FIG. 3 is a top view of the cookware of the present invention;

FIG. 4 is a cross sectional view, taken along line 4-4 in FIG. 3;

FIG. 5 is a cross sectional view, taken along line 5-5 in FIG. 3, and

FIG. 6 is a cross sectional view to show that the cookware of the present invention is cooking food.

### DETAILED DESCRIPTION OF THE PREFERRED EMBODIMENT

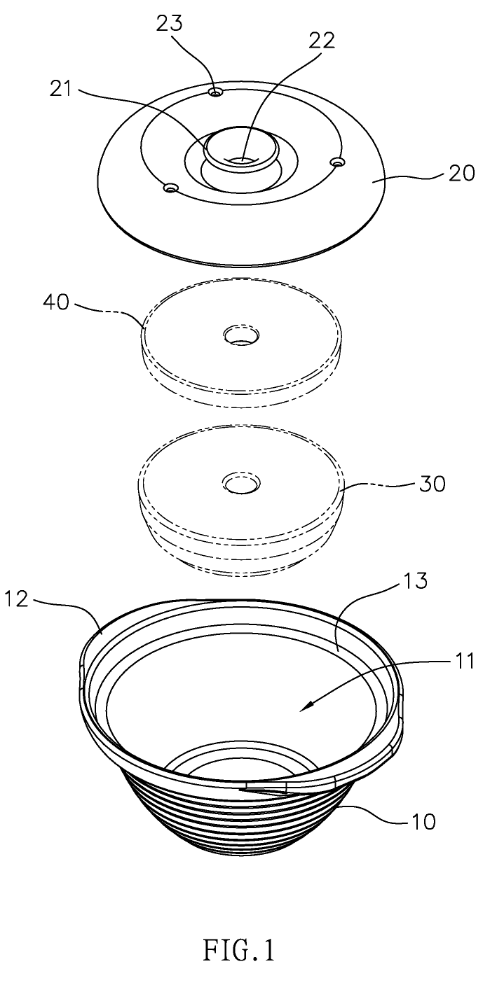

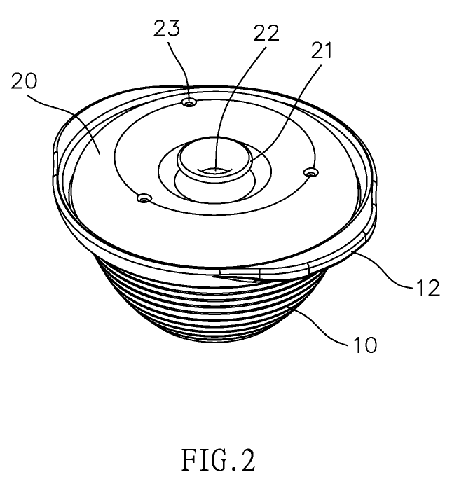

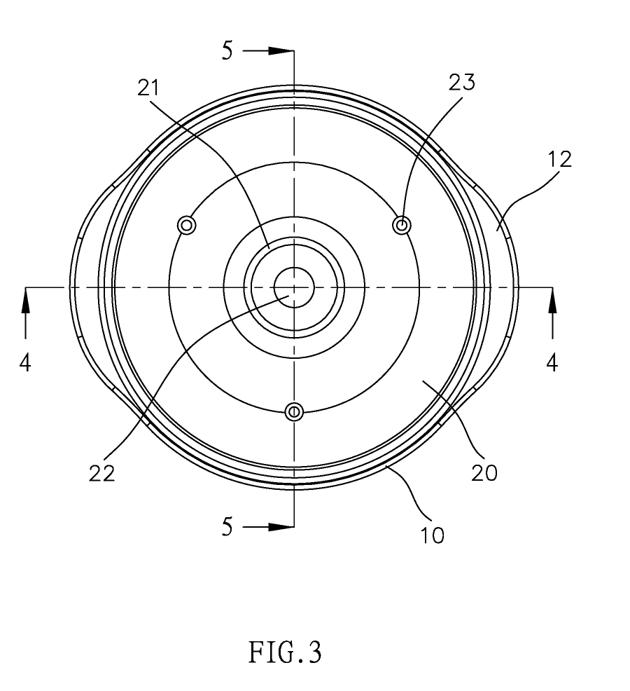

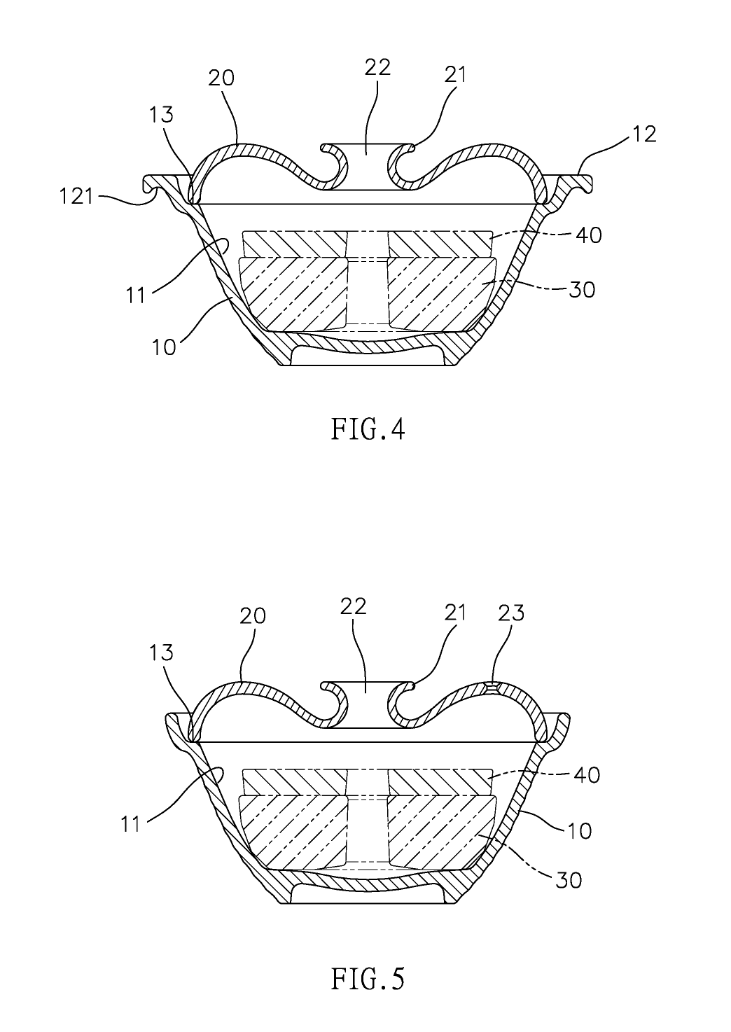

Referring to FIGS. 1 to 6, the cookware of the present invention comprises a body 10 and a cover 20, wherein the body 10 is a circular bowl-shaped part and has an opening defined in the top thereof. A space 11 is defined in the body 10 and communicates with the opening. A stepped portion 13 is defined in the inner periphery of the body 10, and the stepped portion is located close to the opening. Two lugs 12 extend from outside of the body 10 and are located close to the top of the body 10. Each of the lugs 12 has a groove 121 defined in the underside thereof so as to provide proper friction for grip by the users.

The cover 20 is a circular part and has a handle 21 extending centrally from the top thereof. A first hole 22 is defined centrally through the handle. The cover 20 is removably mounted to the body 10 and seals the opening by resting on the stepped portion 13 of the body 10. The cover 20 includes at least one second hole 23 defined therethrough.

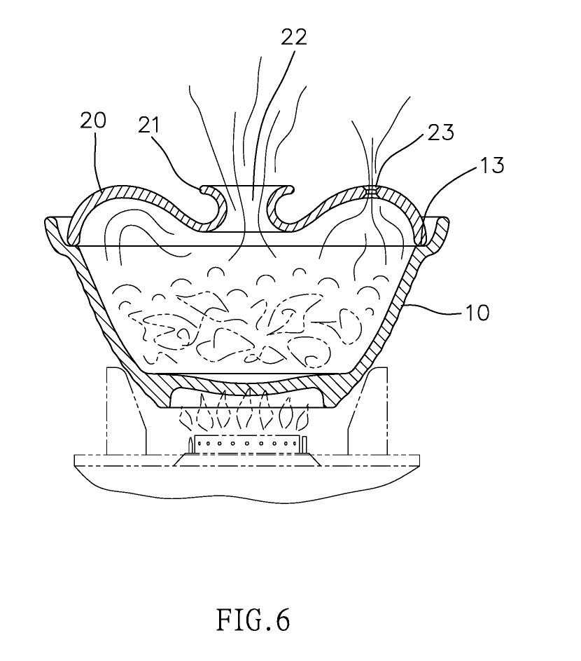

When in use, as shown in FIG. 6, the noodles 30, the soup cube 40 and water are put in the space of the body 10, the cover 20 is put on the body 10 and the cookware is heated on a stove. The heat creates vapor and steam in the body 10. The vapor and steam circulate within the inside of the cover 20 and escape from the first hole 22 and the at least one second hole 23. Therefore, no water drops are formed and drop from the cookware so as to keep the kitchen clean. Besides, the pressure can be controlled and managed.

The users may also add hot water or broth into the body 10 from the first hole 22 to quickly heat the food in the body 10. The lugs 12 each have a groove 121 in the underside thereof and the users hold the lugs 12 by the grooves 121 easily and firmly.

It is noticed that each of the body 10 and the cover 20 can also be a rectangular or any suitable shape part.

While we have shown and described the embodiment in accordance with the present invention, it should be clear to those skilled in the art that further embodiments may be made without departing from the scope of the present invention.

What is claimed is:

1. A cookware comprising:
a body having an opening defined in a top thereof, a space defined in the body and communicating with the opening, two lugs extending from outside of the body and located close to a top of the body, and
a cover having a handle extending centrally from a top thereof, a first hole defined centrally through the handle, the cover removably mounted to the body and sealing the opening.

2. The cookware as claimed in claim 1, wherein the body has a stepped portion defined in an inner periphery thereof, the stepped portion is located close to the opening, the cover is rested on the stepped portion.

3. The cookware as claimed in claim 1, wherein the cover includes at least one second hole defined therethrough.

4. The cookware as claimed in claim 1, wherein each of the lugs 12 has a groove 121 defined in an underside thereof.

5. The cookware as claimed in claim 1, wherein each of the body 10 and the cover is a circular part.

6. The cookware as claimed in claim 1, wherein each of the body and the cover is a rectangular part.
